(19) United States
(12) Patent Application Publication
(10) Pub. No.: US 2022/0049970 A1
(43) Pub. Date: Feb. 17, 2022

(54) SERVER, NON-TRANSITORY COMPUTER READABLE MEDIUM, AND COMMUNICATION APPARATUS

(71) Applicant: Toyota Jidosha Kabushiki Kaisha, Toyota-shi Aichi-ken (JP)

(72) Inventors: Taiki Yamashita, Toyota-shi Aichi-ken (JP); Daiki Kubo, Toyota-shi Aichi-ken (JP); Jake Morrow, Carrolton, TX (US)

(21) Appl. No.: 17/397,037

(22) Filed: Aug. 9, 2021

(30) Foreign Application Priority Data
Aug. 11, 2020 (JP) 2020-136053

(51) Int. Cl. G01C 21/36; G01C 21/34

(52) U.S. Cl. CPC G01C 21/3617; G01C 21/3484; G01C 21/3438; G01C 21/3492

(57) ABSTRACT

A server according to the present disclosure includes a communication interface and a controller. The controller receives, from a vehicle via the communication interface, boarding information indicating a user who is on board the vehicle and positional information for the vehicle, and determines, using association information associating users who can board the vehicle with allowable ranges of travel, whether the vehicle is located within an allowable range of travel associated with the user who is on board the vehicle.

### CROSS-REFERENCE TO RELATED APPLICATION

This application claims priority to Japanese Patent Application No. 2020-136053, filed on Aug. 11, 2020, the entire contents of which are incorporated herein by reference.

### TECHNICAL FIELD

The present disclosure relates to a server, a program, and a communication apparatus.

### BACKGROUND

Technology for limiting a range where a vehicle can be used is known. For example, Patent Literature (PTL) 1 discloses a vehicle management system configured to make a notification, when the position of a vehicle is, or is expected to be, out of a range where the vehicle can be used.

### CITATION LIST

### Patent Literature

PTL 1: JP 2019-109824 A

### SUMMARY

In recent years, there has been a need to further improve the utility of technology for limiting a range where a vehicle can be used.

It would be helpful to provide a server, a program, and a communication apparatus, which improve the utility of technology for limiting a range where a vehicle can be used.

A server according to an embodiment of the present disclosure includes:
a communication interface; and
a controller configured to:
   receive, from a vehicle via the communication interface, boarding information indicating a user who is on board the vehicle and positional information for the vehicle; and
   determine, using association information associating users who can board the vehicle with allowable ranges of travel, whether the vehicle is located within an allowable range of travel associated with the user who is on board the vehicle.

A program according to an embodiment of the present disclosure is configured to cause a computer to execute operations, the operations including:
receiving, from a vehicle via the communication interface, boarding information indicating a user who is on board the vehicle and positional information for the vehicle; and
determining, using association information associating users who can board the vehicle with allowable ranges of travel, whether the vehicle is located within an allowable range of travel associated with the user who is on board the vehicle.

A communication apparatus according to an embodiment of the present disclosure is included in a vehicle, the communication apparatus including:
a communication interface; and
a controller configured to transmit, to a server via the communication interface, information indicating a user who is on board the vehicle and positional information for the vehicle, and cause the server to determine, using association information associating users who can board the vehicle with allowable ranges of travel, whether the vehicle is located within an allowable range of travel associated with the user who is on board the vehicle.

A server, a program, and a communication apparatus according to an embodiment of the present disclosure improve the utility of technology for limiting a range where a vehicle can be used.

### BRIEF DESCRIPTION OF THE DRAWINGS

In the accompanying drawings:

FIG. 1 is a diagram illustrating a schematic configuration of an information processing system according to an embodiment of the present disclosure;

FIG. 2 is a block diagram illustrating a configuration of a vehicle according to an embodiment;

FIG. 3 is a block diagram illustrating a configuration of a server according to an embodiment;

FIG. 4 is a block diagram illustrating a configuration of a terminal apparatus according to an embodiment;

FIG. 5 is a table illustrating association information in an embodiment;

FIG. 6 is a schematic diagram illustrating allowable ranges of travel in an embodiment;

FIG. 7 is a flowchart illustrating first operations of the information processing system illustrated in FIG. 1;

FIG. 8 is a flowchart illustrating operations of the information processing system, following those of FIG. 7; and

FIG. 9 is a flowchart illustrating second operations of the information processing system illustrated in FIG. 1.

### DETAILED DESCRIPTION

Hereinafter, an embodiment of the present disclosure will be described.

In the drawings, the same or corresponding portions are denoted by the same reference numerals. In the descriptions of the present embodiment, detailed descriptions of the same or corresponding portions are omitted or simplified as appropriate.

(Configuration of Information Processing System)

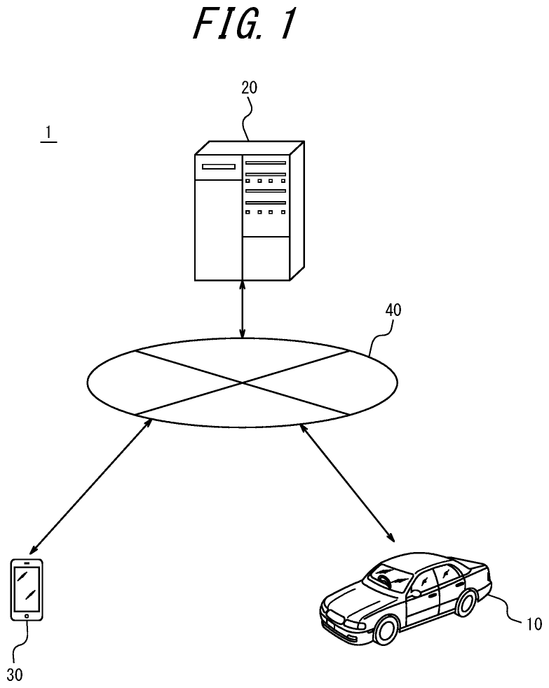

With reference to FIG. 1, an outline of the information processing system 1 according to the present embodiment will be described. FIG. 1 is a diagram illustrating a schematic configuration of the information processing system 1. The information processing system 1 includes a vehicle 10, a server 20, and a terminal apparatus 30. FIG. 1 illustrates one each of the vehicle 10, the server 20, and the terminal apparatus 30. However, the information processing system 1 may include any number of vehicles 10, servers 20, and terminal apparatuses 30.

The vehicle 10 is, for example, an automobile. However, the vehicle 10 may be any vehicle such as a motorcycle or a bicycle, without being limited to an automobile. The vehicle 10 may be driven by a driver, or the driving may be automated at any level. The level of automation is, for example, one of level 1 to level 5 in the level classification of the Society of Automotive Engineers (SAE).

The server 20 is configured by one or more computers. In the present embodiment, the server 20 will be described as being configured by a single computer. However, the server 20 may be configured by multiple computers, such as a cloud computing system.

The terminal apparatus 30 is, for example, a mobile phone, a smartphone, or a computer such as a personal computer. In the present disclosure, a computer is also referred to as an information processing apparatus. In the present embodiment, the terminal apparatus 30 is used by, for example, an owner of the vehicle 10.

An owner of the vehicle 10 uses the terminal apparatus 30 to check the position of the vehicle 10. The terminal apparatus 30 communicates with the server 20 to receive information indicating a determination result as to whether the vehicle 10 is located within an allowable range of travel. The terminal apparatus 30 displays, for example, through a display, that the vehicle 10 is out of an allowable range of travel, based on the information indicating the determination result received from the server 20.

The network 40 is any communication network that enables the vehicle 10, the server 20, and the terminal apparatus 30 to communicate with one another. For example, the network 40 in the present embodiment may include an ad hoc network, a Metropolitan Area Network (MAN), a cellular network, a Wireless Personal Area Network (WPAN), the Public Switched Telephone Network (PSTN), a Terrestrial Wireless Network, an optical network, or another type of networks, or a combination of any of these.

The information processing system 1 is used for, for example, a service of monitoring whether the vehicle 10 is located within an allowable range defined by an owner of the vehicle 10.

In the information processing system 1, the vehicle 10 is a share car that an owner of the vehicle 10 allows other users to use. The server 20 stores in advance association information associating users who can board the vehicle 10 with allowable ranges of travel. For example, the association information may be registered by an owner of the vehicle 10. The server 20 communicates with the vehicle 10 to receive, from the vehicle 10, information indicating a user who is on board the vehicle 10 and positional information for the vehicle 10. The server 20 determines, using the association information, whether the vehicle 10 is located within an allowable range associated with the user who is on board the vehicle 10. This enables the information processing system 1 to improve the utility of technology for limiting a range where the vehicle 10 can be used.

In the present disclosure, “user” of the vehicle 10 is a person who uses the vehicle 10. Examples of the user of the vehicle 10 include an owner of the vehicle 10, a family member of the owner, and a person designated by the owner as the user of the vehicle 10. The using of the vehicle 10 is not limited to driving the vehicle 10, and includes being on board as a fellow passenger on the vehicle 10 driven by another person. In the present disclosure, “allowable range of travel” for the vehicle 10 is a geographic range in which the vehicle 10 is allowed to move, as will be described later.

Next, the vehicle 10, the server 20, and the terminal apparatus 30 of the information processing system 1 will be described in detail.

(Configuration of Vehicle)

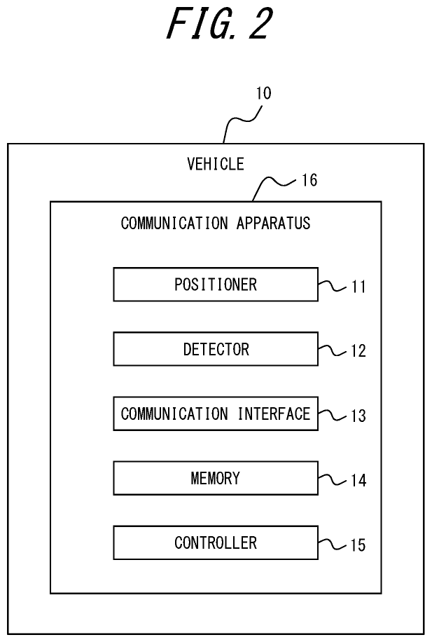

With reference to FIG. 2, a configuration of the vehicle 10 according to the present embodiment will be described. FIG. 2 is a block diagram illustrating the configuration of the vehicle 10. As illustrated in FIG. 2, the vehicle 10 includes a positioner 11, a detector 12, a communication interface 13, a memory 14, and a controller 15. The positioner 11, the detector 12, the communication interface 13, the memory 14, and the controller 15 are connected via an in-vehicle network such as a Controller Area Network (CAN) or dedicated lines so as to be able to communicate with one another by wire or wirelessly.

In the present embodiment, the description is given on the assumption that the communication apparatus 16 included in the vehicle 10 has all the functions of the positioner 11, the detector 12, the communication interface 13, the memory 14, and the controller 15. The communication apparatus 16 is, for example, an in-vehicle apparatus such as an Electronic Control Unit (ECU), a car navigation apparatus, or an in-vehicle communication device. Alternatively, the communication apparatus 16 may be a mobile phone, a smartphone, or a computer such as a personal computer, installed on the vehicle 10. However, some of the functions described above may be provided by another in-vehicle apparatus mounted in the vehicle 10 that is communicably connected to the communication apparatus 16.

The positioner 11 measures the position of the vehicle 10, and generates positional information for the vehicle 10. Positional information for a vehicle 10 is, for example, coordinates such as the two-dimensional coordinates or three-dimensional coordinates of a point where the vehicle 10 is located. A car navigation apparatus included in the vehicle 10 may function as the positioner 11.

In the present embodiment, the positioner 11 can measure the position of the vehicle 10 by a combination of navigation using a satellite positioning system and autonomous navigation. The positioner 11 includes a receiver corresponding to a satellite positioning system for measuring the position of the vehicle 10 by navigation using the satellite positioning system. The satellite positioning system which the receiver corresponds to may be, for example, the Global Positioning System (GPS). Further, the positioner 11 includes a sensor, such as an acceleration sensor or a gyro sensor, for measuring the position of the vehicle 10 by autonomous navigation. However, the positioner 11 may measure the position of the vehicle 10 by either one of navigation using a satellite positioning system and autonomous navigation.

The detector 12 detects a user who is on board the vehicle 10, and generates information indicating the user who is on board the vehicle 10. For example, the detector 12 includes a camera. In such a case, the detector 12 is installed at a position, such as a ceiling of the cabin, from which a user who is on board the vehicle 10 can be photographed. The detector 12 captures an image of a part of a user who is on board the vehicle 10, such as the face of the user, based on which the user can be uniquely identified. However, the camera included in the detector 12 may be installed at a position from which a user who is getting on or off the vehicle 10 can be photographed. The detector 12 generates the photographed image as the information indicating a user who is on board the vehicle 10.

The detector 12 may include a wireless communication module such as an electronic tag reader. In such a case, the detector 12 acquires, through wireless communication, information such as user identification information stored in, for example, an electronic tag or a computer possessed by a user who is on board the vehicle 10. The user identification information is information for uniquely identifying the user. The user identification information is, for example, information assigned by the server 20. The detector 12 generates the acquired user identification information, as the information indicating a user who is on board the vehicle 10. The wireless communication method supported by the wireless communication module may be, for example, short-range wireless communication standard such as Radio Frequency Identification (RFID), Near Field Communication (NFC), Ultra-High Frequency (UHF), Wi-Fi® (Wi-Fi is a registered trademark in Japan, other countries, or both), Bluetooth® (Bluetooth is a registered trademark in Japan, other countries, or both), or an infrared communication standard.

The communication interface 13 includes a communication module for connecting to the network 40. The communication module is, for example, a communication module compliant with a mobile communication standard such as the 4th Generation (4G) standard or the 5th Generation (5G) standard. The communication module may be, for example, a communication module compliant with a standard such as a wired Local Area Network (LAN) standard or a wireless LAN standard. The communication module may be a communication module compliant with the aforementioned short-range wireless communication standard. In the present embodiment, the vehicle 10 is connected to the network 40 via the communication interface 13. This enables the vehicle 10 to communicate with the server 20 or the like.

The memory 14 is, for example, a semiconductor memory, a magnetic memory, an optical memory, or the like. The memory 14 functions as, for example, a main memory, an auxiliary memory, or a cache memory. The memory 14 stores any information used for operations of the vehicle 10. For example, the memory 14 stores a system program, an application program, embedded software, or the like. The information stored in the memory 14 may be updated with, for example, information acquired from the network 40 via the communication interface 13.

The controller 15 includes at least one processor. The processor may be, for example, a general purpose processor such as a Central Processing Unit (CPU), a dedicated processor that is dedicated to specific processing, or the like. The controller 15 is not limited to a processor and may include at least one dedicated circuit. Examples of the dedicated circuit may include a Field-Programmable Gate Array (FPGA) and an Application Specific Integrated Circuit (ASIC). The controller 15 controls the components such as the positioner 11, the detector 12, the communication interface 13, and the memory 14 that are described above in order to realize the functions of the communication apparatus 17, including the functions of the components.

The functions of the communication apparatus 16 are realized by executing a communication apparatus program according to the present embodiment on a processor of a computer. That is, the functions of the communication apparatus 16 are realized by software. The communication apparatus program is a program for causing a computer to execute the processing of steps included in operations of the communication apparatus 16, thereby enabling the computer to realize the functions corresponding to the processing of the steps. That is, the communication apparatus program is a program for causing the computer to function as the communication apparatus 16.

The program can be recorded on a non-transitory computer readable recording medium. The non-transitory computer readable recording medium is, for example, a magnetic recording device, an optical disc, a magneto-optical recording medium, or a semiconductor memory. The distribution of the program is performed by, for example, sale, transfer, or rental of a portable recording medium such as a digital versatile disc (DVD) or a compact disc read only memory (CD-ROM) on which the program is recorded. Alternatively, the program may be distributed by storing the program in a storage of a predetermined server and transferring the program from the server to another computer. The program may also be provided as a program product.

The computer temporarily stores, for example, a program recorded on a portable recording medium or a program transferred from a predetermined server, in a memory. Then, the computer reads the program stored in the memory using a processor, and executes processing in accordance with the read program using the processor. The computer may read a program directly from a portable recording medium, and execute processing in accordance with the program. Each time a program is transferred from the predetermined server to the computer, the computer may execute processing in accordance with the received program in order. The processing may be executed through a so-called application service provider (ASP) type service which realizes functions merely by execution of instructions and acquisition of results, without transferring the program from the predetermined server to the computer. Programs encompass information that is to be used for processing by a computer and is thus equivalent to a program. For example, data that is not a direct command to a computer but has a property that regulates processing of the computer is “equivalent to a program” in this context.

(Configuration of Server)

With reference to FIG. 3, a configuration of the server 20 according to the present embodiment will be described. FIG. 3 is a block diagram illustrating the configuration of the server 20. As illustrated in the block diagram of FIG. 3, the server 20 includes a communication interface 21, a memory 22, and a controller 23. The communication interface 21, the memory 22, and the controller 23 are connected so as to be able to communicate with one another by wire or wirelessly.

The communication interface 21 includes a communication module for connecting to the network 40. The communication module is, for example, a communication module compliant with a mobile communication standard such as the 4G standard or the 5G standard. The communication module may be, for example, a communication module compliant with a standard such as a wired LAN standard or a wireless LAN standard. The communication module may be a communication module compliant with the aforementioned short-range wireless communication standard. In the present embodiment, the server 20 is connected to the network 40 via the communication interface 21. This enables the server 20 to communicate with the vehicle 10 and the terminal apparatus 30.

The memory 22 is, for example, a semiconductor memory, a magnetic memory, an optical memory, or the like. The memory 22 functions as, for example, a main memory, an auxiliary memory, or a cache memory. The memory 22 stores any information to be used for operations of the server 20. The memory 22 stores, for example, a system program, an application program, embedded software, a database, or the like. The information stored in the memory 22 may be updated with, for example, information acquired from the network 40 via the communication interface 21.

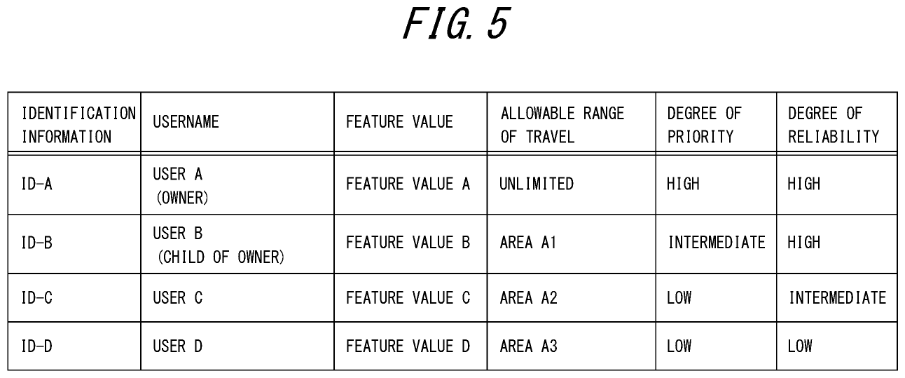

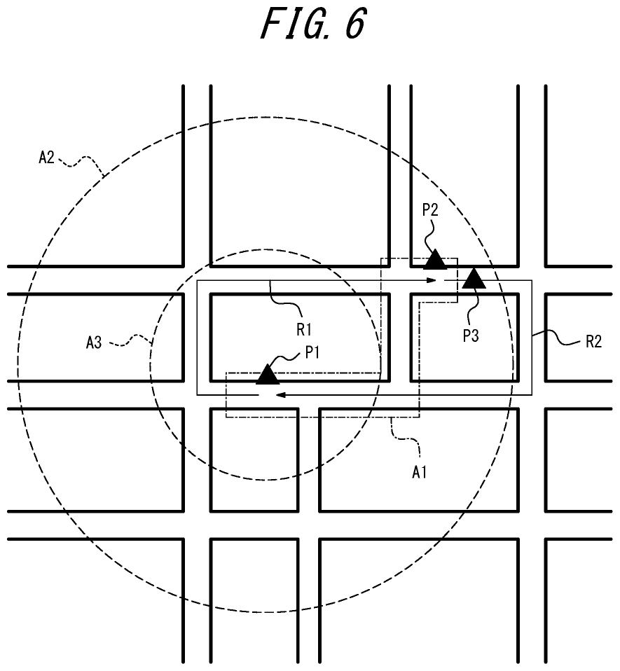

The memory 22 stores, for example, association information associating users who can board a vehicle 10 with allowable ranges of travel. The association information may be defined for each vehicle 10 by an owner of the vehicle 10. With reference to FIGS. 5 and 6, an example of the association information will be described. FIG. 5 illustrates the association information in an embodiment. FIG. 6 is a schematic diagram illustrating the allowable ranges of travel in an embodiment. The association information includes, for example, identification information, a username, a feature value, an allowable range of travel, a degree of priority, and a degree of reliability.

The identification information is information capable of uniquely identifying each user. The identification information may be managed in association with information capable of uniquely identifying the terminal apparatus 30. This enables the server 20 to identify, using the identification information, the terminal apparatus 30 used by each user.

The username is information indicating the name of each user. Unlike the identification information, the username may not be able to uniquely identify each user.

The feature value is information indicating the feature of each user. For example, the feature value is information indicating a feature of the face of each user, which is extracted from an image obtained by photographing the face of each user, through image processing such as face recognition.

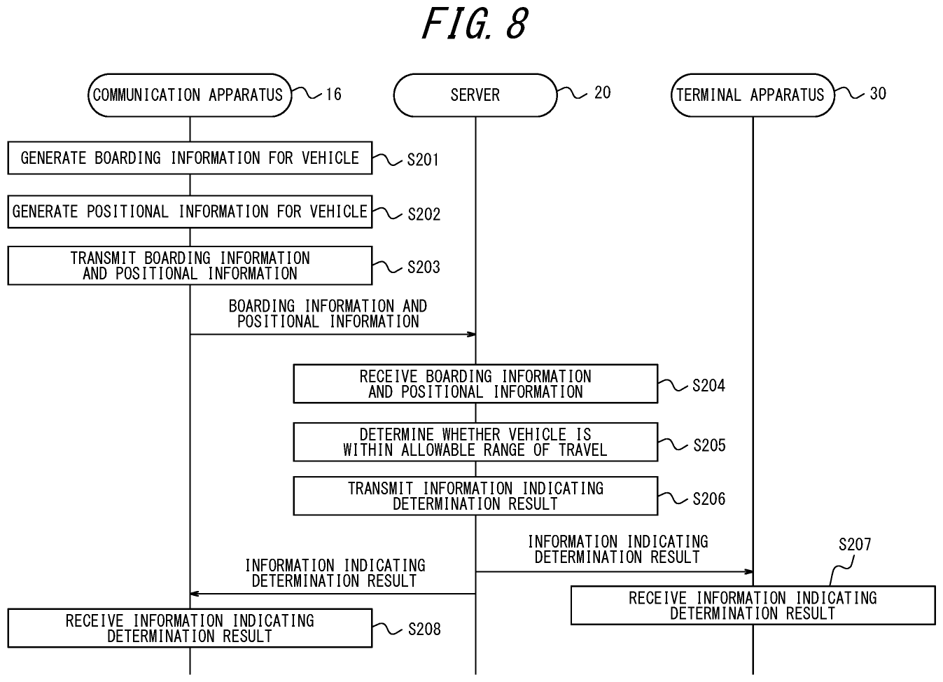

As described above, the allowable range of travel is a geographic range in which the vehicle 10 is allowed to move. In the present embodiment, the allowable range of travel is an area surrounded by a virtual geographic boundary. Hereinafter, the virtual geographic boundary is also referred to as a “geofence” and an area surrounded by the virtual geographic boundary is also referred to as a “geofence area”. The allowable range of travel may be a two-dimensional area or a three-dimensional area in any shape. For example, the allowable range of travel may be a circular area having a certain point as the center and a predetermined distance as the radius, as illustrated as the area A2 or the area A3 each indicated by the broken line of FIG. 8. Alternatively, the allowable range of travel may be an area provided, for example, along a road on which the vehicle 10 can travel, as illustrated as the area A1 indicated by the dashed line of FIG. 8.

The degree of priority is a parameter that indicates the priority of a user. As will be described later, in a case in which a plurality of users is on board the vehicle 10, an allowable range of travel associated with a user who whose degree of priority is highest among the plurality of users may be defined as the allowable range of travel for the vehicle 10. For example, in the present embodiment, the degree of priority is assumed to be defined and managed in three levels of high, intermediate, and low.

The degree of reliability is a parameter indicating the reliability of a user. The allowable ranges of travel may be defined according to the degrees of reliability of the users. Specifically, the allowable range of travel may be defined wider as the degree of reliability of the user is higher. The degrees of reliability of the users may be defined, for example, based on activities of the users in a social networking service. Information posted by a user in a social networking service is subjected to natural language processing or image processing, and when an inappropriate keyword or image is included therein, a lower degree of reliability may be assigned to the user. Alternatively, the degree of reliability of a user may be defined based on a use record of the vehicle 10 by the user. The use record includes, for example, the number of times of departures from the allowable range of travel, the number of times of sudden starts or stops, the accident history in the past, or the number of times of uses of the vehicle 10. In the present embodiment, the degree of reliability is defined and managed in three levels of high, intermediate, and low.

The information included in the association information is not limited to the aforementioned examples. The association information may include information indicating a category into which a user is classified according to the degree of reliability, the degree of priority, or the like. The allowable ranges of travel may each be defined per category. For example, users may be classified into a plurality of categories according to the degrees of reliability of the users, and the allowable ranges of travel may each be defined per category. This enables to save the processing capacity of the server 20, such as the processing speed and the amount of data, which is otherwise required for managing the association information, as compared with the case in which the allowable range of travel is individually defined for each user.

In the association information, a plurality of allowable ranges of travel may be associated with one user. For example, the allowable ranges of travel may be defined according to time of day when the users board the vehicle 10. A user may be associated with an allowable range of travel for daytime (e.g., from 6:00 a.m. to 6:00 p.m.) and an allowable range of travel for nighttime (e.g., from 6:00 p.m. to 6:00 a.m.). The allowable range of travel for nighttime, during which the visibility is poor, may be narrower than the allowable range of travel for daytime.

The controller 23 includes at least one processor. The processor may be, for example, a general purpose processor such as a CPU, a dedicated processor that is dedicated to specific processing, or the like. The controller 23 is not limited to a processor and may include at least one dedicated circuit. Examples of the dedicated circuit may include an FPGA and an ASIC. The controller 23 controls the components such as the communication interface 21 and the memory 22 that are described above in order to realize the functions of the server 20, including the functions of the components.

The functions of the server 20 are realized by execution of a control program according to the present embodiment by a processor of a computer. That is, the functions of the server 20 are realized by software. The control program is a program for causing a computer to execute the processing of steps included in operations of the server 20, thereby enabling the computer to realize the functions corresponding to the processing of the steps. That is, the control program is a program for causing a computer to function as the server 20.

(Configuration of Terminal Apparatus)

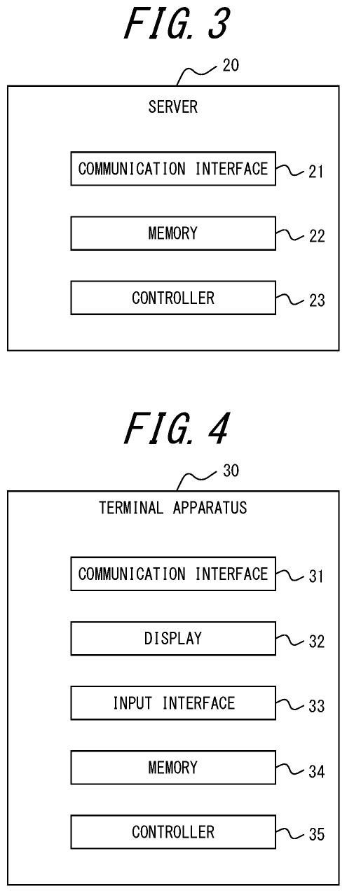

With reference to FIG. 4, a configuration of the terminal apparatus 30 according to the present embodiment will be described. FIG. 4 is a block diagram illustrating the configuration of the terminal apparatus 30. As illustrated in the block diagram of FIG. 4, the terminal apparatus 30 includes a communication interface 31, a display 32, an input interface 33, a memory 34, and a controller 35. The communication interface 31, the display 32, the input interface 33, the memory 34, and the controller 35 are connected so as to be able to communicate with one another by wire or wirelessly.

The communication interface 31 includes a communication module for connecting to the network 40. The communication module is, for example, a communication module compliant with a mobile communication standard such as the 4G standard or the 5G standard. The communication module may be, for example, a communication module compliant with a standard such as a wired LAN standard or a wireless LAN standard. The communication module may be a communication module compliant with the aforementioned short-range wireless communication standard. In the present embodiment, the terminal apparatus 30 is connected to the network 40 via the communication interface 31. This enables the terminal apparatus 30 to communicate with the server 20 or the like.

The display 32 displays information as an image or in text. The display 32 includes a display device such as a monitor.

The input interface 33 accepts input operations. The input interface 33 includes, for example, an input device such as a touch panel, a physical key, a camera, a microphone, or an IC card reader.

The memory 34 is, for example, a semiconductor memory, a magnetic memory, an optical memory, or the like. The memory 34 functions as, for example, a main memory, an auxiliary memory, or a cache memory. The memory 34 stores any information use for operations of the terminal apparatus 30. The memory 34 stores a system program, an application program, embedded software, a database, or the like. The information stored in the memory 34 may be updated with, for example, information acquired from the network 40 via the communication interface 31.

The controller 35 includes at least one processor. The processor may be, for example, a general purpose processor such as a CPU, a dedicated processor that is dedicated to specific processing, or the like. The controller 15 is not limited to a processor and may include at least one dedicated circuit. Examples of the dedicated circuit may include an FPGA and an ASIC. The controller 35 controls the functions of the components such as the communication interface 31, the display 32, the input interface 33, and the memory 34 that are described above in order to realize the functions of the terminal apparatus 30, including the functions of the components.

The functions of the terminal apparatus 30 are realized by executing a control program according to the present embodiment on a processor of the computer. In other words, the functions of the terminal apparatus 30 are realized by software. The control program is a program for causing a computer to execute the processing of steps included in operations of the terminal apparatus 30, thereby enabling the computer to realize the functions corresponding to the processing of the steps. That is, the control program is a program for causing the computer to function as the terminal apparatus 30.

(Operations 1 of Information Processing System)

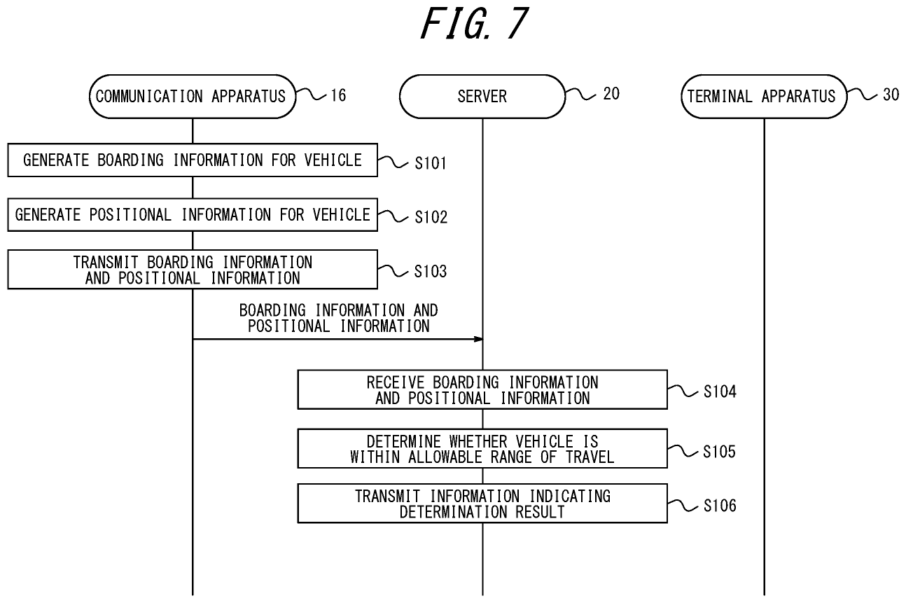

With reference to FIGS. 5, 6, 7, and 8, first operations of the information processing system 1 will be described. The information processing system 1 is used for determining whether a vehicle 10 is located within an allowable range of travel associated with a user who is on board the vehicle 10. FIG. 7 is a flowchart illustrating the first operations of the information processing system 1. FIG. 8 is a flowchart illustrating operations of the information processing system 1, following those of FIG. 7. The first operations are explained on the assumption that the communication apparatus 16 is included in the vehicle 10. Therefore, the operations of the communication apparatus 16 can also be deemed as the operations of the vehicle 10 that includes the communication apparatus 16. Further, the first operations are explained on the assumption that the server 20 stores, in the memory 22 in advance, association information associating users who can board the vehicle 10 with allowable ranges of travel.

The first operations are explained on the assumption that a user A who is an owner of the vehicle 10 requests a user C to board the vehicle 10 and pick up from school a user B who is a child of the owner. As illustrated in FIG. 6, the vehicle 10 is parked in advance at a point P1 where a house of the user A is located. The user C travels by the vehicle 10 from the point P1 to a point P2 where the school is located, through a route R1. Thereafter, the user C picks up the user B by the vehicle 10 at the point P2, and moves from the point P2 to the point P1 through a route R2 by the vehicle 10.

First, with reference to FIGS. 6 and 7, operations of the information processing system 1 to be performed during when the vehicle 10 moves from the point P1 to the point P2 through the route R1 will be described.

As illustrated in FIG. 7, in Step S101, the controller 15 of the communication apparatus 16 controls the detector 12 to generate boarding information indicating a user who is on board the vehicle 10. The controller 15 stores the generated boarding information for the vehicle 10, in the memory 14. The controller 15 may execute this processing at a predetermined timing. For example, the controller 15 repeatedly executes this processing at predetermined time intervals after the engine of the vehicle 10 is turned on. However, the predetermined timing may be a timing at which a given operation is detected, the given operation including opening or closing of the door of the vehicle 10, locking or unlocking of the vehicle 10, turning on or off of the engine of the vehicle 10, or the like.

Specifically, the controller 15 of the communication apparatus 16 controls the detector 12 to generate boarding information indicating a user who is on board the vehicle 10. For example, when the detector 12 includes a camera, the controller 15 generates an image obtained by photographing the face of a user inside the cabin with the camera, as the information indicating a user who is on board the vehicle 10. When the detector 12 includes an electronic tag reader, the controller 15 generates user identification information acquired from an electronic tag of the user by the electronic tag reader, as the information indicating a user who is on board the vehicle 10.

In Step S102, the controller 15 of the communication apparatus 16 controls the positioner 11, and generates positional information for the vehicle 10. The controller 15 stores the generated positional information for the vehicle 10, in the memory 14.

In Step S103, the controller 15 of the communication apparatus 16 transmits, to the server 20 via the communication interface 13, boarding information indicating a user who is on board the vehicle 10 and the positional information for the vehicle 10.

In the example of FIG. 6, the user C gets on board the vehicle 10 at the point P1 and turns on the engine of the vehicle 10. The controller 15 of the communication apparatus 16 generates an image I1 obtained by photographing the face of the user C with the camera of the detector 12, as the information indicating a user who is on board the vehicle 10. The controller 15 measures, by the positioner 11, the coordinates of the point P1, and generates information indicating the measured coordinates as the positional information for the vehicle 10. The controller 15 transmits, to the server 20 via the communication interface 13, the image I1 obtained by photographing the face of the user C and the coordinates of the point P1 at which the vehicle 10 is located.

With reference again to FIG. 7, in Step S104, the controller 23 of the server 20 receives, via the communication interface 21 from the vehicle 10, the boarding information indicating a user who is on board the vehicle 10 and the positional information for the vehicle 10. The controller 23 stores the received boarding information indicating a user who is on board the vehicle 10 and the received positional information for the vehicle 10, in the memory 22.

In Step S105, the controller 23 of the server 20 determines, using the association information associating users who can board the vehicle 10 with allowable ranges of travel, whether the vehicle 10 is located within an allowable range of travel associated with a user who is on board the vehicle 10.

Specifically, the controller 23 determines the user who is on board the vehicle 10, based on the boarding information indicating a user who is on board the vehicle 10. For example, when the boarding information indicating a user who is on board the vehicle 10 includes an image obtained by photographing the face of the user, the controller 23 extracts a feature value of the human face included in the image using image processing such as face recognition. The controller 23 compares the extracted feature value of the human face with the feature value of the face of each user included in the association information. In a case in which the association information includes a user whose feature value of the face coincides with the extracted feature value of the human face, the controller 23 determines that the user is on board the vehicle 10. In a case in which the boarding information indicating a user who is on board the vehicle 10 includes identification information for a user, the controller 23 determines that the user who is assigned such identification information is on board the vehicle 10.

Next, the controller 23 determines, using the association information, whether the vehicle is located within an allowable range of travel associated with the user who is determined as being on board the vehicle. The controller 23 may use an application such as a Geographic Information System (GIS) for the determination. The controller 23 starts the GIS, and maps the positional information for the vehicle 10 and an allowable range of travel associated with the user who is determined as being on board the vehicle 10 on the map, so as to determine whether the vehicle 10 is located within the allowable range of travel.

In Step S106, the controller 23 of the server 20 transmits, in a case in which it is determined that the vehicle 10 is not located within the allowable range of travel, information indicating the determination result as to whether the vehicle 10 is located within the allowable range of travel, via the communication interface 21.

The information indicating the determination result includes, for example, information on a map to be displayed and information indicating the position and the allowable range of travel for the vehicle 10 mapped on the map. The controller 23 transmits the information indicating the determination result to the terminal apparatus 30 used by an owner of the vehicle 10. This enables the controller 35 to display, on the display 32, a warning that the vehicle 10 is located outside the allowable range of travel. Alternatively, the controller 23 may transmit the information indicating the determination result, to the communication apparatus 16 of the vehicle 10 via the communication interface 21. This enables the communication apparatus 16 to display, on a display or the like of a car navigation system, a warning that the vehicle 10 is located outside the allowable range of travel. However, the controller 23 may transmit, even when it is determined that the vehicle 10 is located within the allowable range of travel, the information indicating the determination result to at least one of the communication apparatus 16 and the terminal apparatus 30.

In the example of FIG. 6, the controller 23 of the server 20 receives, from the communication apparatus 16, the image I1 obtained by photographing the face of the user C and the coordinates of the point P1 at which the vehicle 10 is located. The controller 23 determines, using the association information associating users who can board the vehicle 10 with allowable ranges of travel, that the user C is on board the vehicle 10, based on the image I1. Then, the controller 23 determines that an allowable range of travel associated with the user C is the area A2, as illustrated in FIG. 5. The area A2 is a circular area centered on the point P1. Thus, the controller 23 determines, based on the coordinates of the point P1 and the area A2, that the vehicle 10 is located within an allowable range of travel associated with the user C. The controller 23 does not transmit the information indicating the determination result to either the communication apparatus 16 or the terminal apparatus 30.

Thereafter, the vehicle 10 moves from the point P1 to the point P2 through the route R1 illustrated in FIG. 6. Until the vehicle 10 reaches the point P2, the processing described from Step S101 to Step S106 is repeatedly performed at predetermined intervals in the information processing system 1. While the vehicle 10 is traveling along the route R1, the controller 23 of the server 20 determines that the vehicle 10 which the user C is on board is located within the area A2 which is an allowable range of travel associated with the user C, and does not transmit information indicating the determination result to either the communication apparatus 16 or the terminal apparatus 30.

Next, with reference to FIGS. 6 and 8, operations of the information processing system 1 to be performed during when the vehicle 10 moves from the point P2 to the point P1 through the route R2 will be described.

As illustrated in FIG. 8, in Step S201, as in Step S101, the controller 15 of the communication apparatus 16 controls the detector 12 to generate boarding information indicating a user who is on board the vehicle 10. The controller 15 stores the generated boarding information for the vehicle 10, in the memory 14.

In Step S202, as in Step S102, the controller 15 of the communication apparatus 16 controls the positioner 11 to generate positional information for the vehicle 10. The controller 15 stores the generated positional information for the vehicle 10, in the memory 14.

In Step S203, as in Step S103, the controller 15 of the communication apparatus 16 transmits, to the server 20 via the communication interface 13, the boarding information indicating a user who is on board the vehicle 10 and the positional information for the vehicle 10.

In the example of FIG. 6, the user C gets on board the vehicle 10 at the point P2 with the user B who is a child of the owner, and turns on the engine of the vehicle 10. The controller 15 of the communication apparatus 16 generates an image 12 obtained by photographing the faces of the user B and the user C with the camera of the detector 12, as the information indicating a user who is on board the vehicle 10. The controller 15 measures, by the positioner 11, the coordinates of the point P2, and generates information indicating the measured coordinates as the positional information for the vehicle 10. The controller 15 transmits, to the server 20 via the communication interface 13, the image 12 obtained by photographing the faces of the users B and C and the coordinates of the point P2 where the vehicle 10 is located.

In Step S204, as in Step S104, the controller 23 of the server 20 receives, from the vehicle 10 via the communication interface 21, the boarding information indicating a user who is on board the vehicle 10 and the positional information for the vehicle 10. The controller 23 stores the received positional information for the vehicle 10 and the received boarding information indicating a user who is on board the vehicle 10, in the memory 22.

In Step S205, as in Step S105, the controller 23 of the server 20 determines, using the association information associating users who can board the vehicle 10 with allowable ranges of travel, whether the vehicle 10 is located within an allowable range of travel associated with a user who is on board the vehicle 10.

In a case in which it is determined that a plurality of users is on board the vehicle 10, the controller 23 may determine whether the vehicle 10 is located within an allowable range of travel associated with at least one user in the plurality of users.

For example, the controller 23 determines whether the vehicle 10 is located within an allowable range of travel associated with a user whose degree of priority is highest among the plurality of users. The controller 23 may determine whether the vehicle 10 is located within an allowable range of travel for a user associated with the narrowest allowable range of travel or for a user associated with the widest allowable range of travel, among the plurality of users. Alternatively, the controller 23 may determine whether the vehicle 10 is located within an allowable range of travel calculated as the logical sum or logical product of the allowable ranges of travel associated with the plurality of users.

In Step S206, as in Step S106, when it is determined that the vehicle 10 is not located within the allowable range of travel, the controller 23 of the server 20 transmits, via the communication interface 21, information indicating the determination result as to whether the vehicle 10 is located within the allowable range of travel. The information indicating the determination result includes, for example, information on a map to be displayed and information indicating the position and the allowable range of travel for the vehicle 10 mapped on the map.

In the example of FIG. 6, the controller 23 of the server 20 receives, from the communication apparatus 16, the image 12 obtained by photographing the faces of the user B and the user C, and the coordinates of the point P2 where the vehicle 10 is located. The controller 23 determines, using the association information, that the user B and the user C are on board the vehicle 10, based on the image 12. The controller 23 determines, using the association information, that an allowable range of travel associated with the user B is the area A1 and an allowable range of travel associated with the user C is the area A2, as illustrated in FIG. 5. The area A1 is an area surrounding a predetermined road from the point P1 to the point P2. The area A2 is a circular area centered on the point P1. As illustrated in FIG. 5, the controller 23 determines, of the area A2 and the area A1, the area A1 that is associated with the user B who is assigned a higher degree of priority as the allowable range of travel. Thus, the controller 23 determines, based on the coordinates of the point P2 and the area A1, that the vehicle 10 is located within an allowable range of travel associated with the user B. The controller 23 does not transmit information indicating the determination result to either the communication apparatus 16 or the terminal apparatus 30.

Thereafter, the vehicle 10 moves from the point P2 to the point P1 along the route R2 illustrated in FIG. 6. While the vehicle 10 is traveling along the route R2, the processing described from Step S201 to Step S206 is repeatedly performed at predetermined time intervals in the information processing system 1. Then, when the vehicle 10 has moved to a point P3, the controller 23 of the server 20 determines that the vehicle 10 which the user B and the user C are on board is not located within the area A1 which is an allowable range of travel associated with the user B. The controller 23 transmits, via the communication interface 21, information indicating the determination result the including the coordinates of the point P3 at which the vehicle 10 is located and mapped on a map and the area A1 which is the allowable range of travel, to the terminal apparatus 30 of an owner of the vehicle 10 and the communication apparatus 16.

With reference again to FIG. 8, in Step S207, the controller 35 of the terminal apparatus 30 receives, via the communication interface 31, information indicating the determination result as to whether the vehicle 10 is located within the allowable range of travel. This enables the controller 35 to display, on the display 32, the position and the allowable range of travel for the vehicle 10 to give a warning to an owner of the vehicle 10.

In Step S208, the controller 15 of the communication apparatus 16 receives, via the communication interface 13, information indicating the determination result as to whether the vehicle 10 is located within the allowable range of travel. This enables the communication apparatus 16 to display, on a display or the like, a point where the vehicle 10 is located and the allowable range of travel on the map, so as to give a warning to a user who is on board the vehicle 10.

(Operations 2 of Information Processing System)

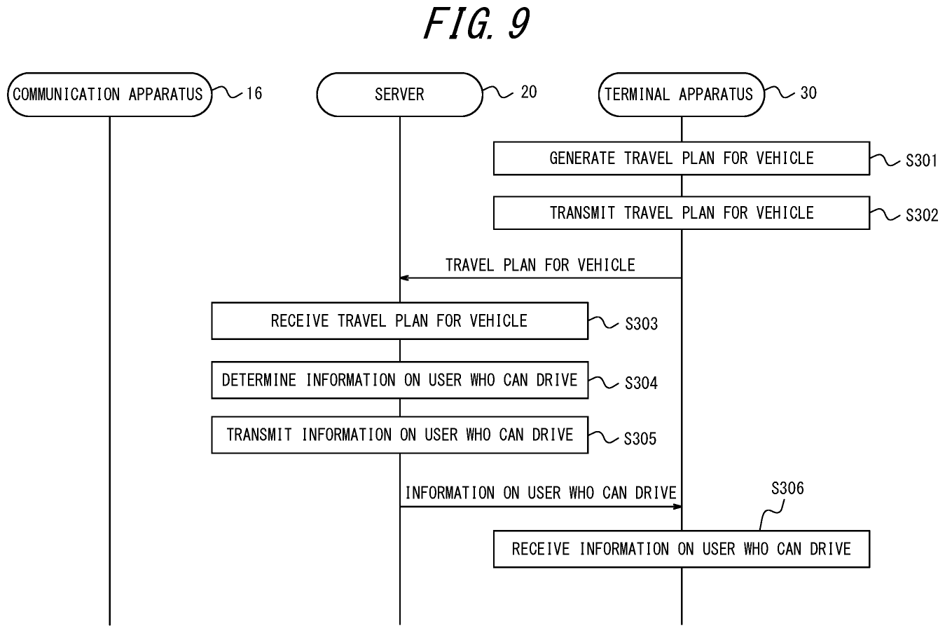

With reference to FIGS. 5, 6, and 9, second operations of the information processing system 1 will be described. The information processing system 1 is used for determining a driver of the vehicle 10 based on the travel plan for the vehicle 10. FIG. 9 is a flowchart illustrating the second operations of the information processing system 1. The second operations are explained on the assumption that the server 20 stores, in the memory 22 in advance, association information associating users who can board the vehicle 10 with allowable ranges of travel.

The second operations are explained on the assumption that the user A, who is an owner of the vehicle 10, is considering who to request to pick up the user B, who is a child of the owner, from school by the vehicle 10. As illustrated in FIG. 6, the vehicle 10 is parked in advance at the point P1 where the house of the user A is located, and the school is located at the point P2.

As illustrated in FIG. 9, in Step S301, the controller 35 of the terminal apparatus 30 accepts, via the input interface 33, an input of a travel plan for the vehicle 10. The travel plan for the vehicle 10 includes the coordinates of the destination. The travel plan for the vehicle 10 may further include information on a user to be on board the vehicle 10 as a fellow passenger.

In Step S302, the controller 35 of the terminal apparatus 30 transmits the travel plan for the vehicle 10 to the server 20 via the communication interface 31.

In Step S303, the controller 23 of the server 20 receives, via the communication interface 21, the travel plan for the vehicle 10 from the terminal apparatus 30. The controller 23 stores the received travel plan for the vehicle 10, in the memory 22.

In Step S304, the controller 23 of the server 20 determines, using the association information, a user who can drive the vehicle 10, based on the travel plan for the vehicle 10.

Specifically, the controller 23 determines, using the association information, a user who can drive the vehicle 10, based on the information on the destination of the vehicle 10. The controller 23 selects, from the association information, a user associated with an allowable range of travel that includes the destination of the vehicle 10, and determines the selected user as the user who can drive the vehicle 10. Further, in a case in which the travel plan for the vehicle 10 includes information on a user to be on board the vehicle 10 as a fellow passenger, the controller 23 may exclude that user and select, from the association information, another user associated with an allowable range of travel that includes the destination of the vehicle 10, and then determine that the selected user as the user who can drive the vehicle 10.

In Step S305, the controller 23 of the server 20 transmits, to the terminal apparatus 30 via the communication interface 21, the information on a user who can drive the vehicle 10.

In Step S306, the controller 35 of the terminal apparatus 30 receives, via the communication interface 31, information on a user who can drive the vehicle 10. This enables the controller 35 to display, on the display 32, the information on a user who can drive the vehicle 10.

For example, the controller 35 of the terminal apparatus 30 accepts, via the input interface 33, an input indicating the coordinates of a point P2 where the school is located as the destination of the vehicle 10 and the user B who is to be dropped off and picked up as the user to be on board the vehicle 10 as a fellow passenger. The controller 35 transmits, to the server 20 via the communication interface 31, a travel plan for the vehicle 10 including the coordinates of the point P2 and the information on the user B. The controller 23 of the server 20 receives the travel plan for the vehicle 10 from the terminal apparatus 30. As illustrated in FIGS. 5 and 6, the controller 23 selects, from the association information, the users A and C who are associated with allowable ranges of travel that include the point P2, and not the user B, and determines the users A and C as the users who can drive. The controller 23 transmits the information on the users A and C who can drive the vehicle 10 to the terminal apparatus 30. This enables the controller 35 of the terminal apparatus 30 to display, on the display 32, the users A and C as the users who can drive the vehicle 10. Therefore, the owner of the vehicle 10 can request the user C to drop off and pick up the child.

As described above, a server 20 according to the present embodiment includes: a communication interface 21; and a controller 23 configured to receive, from a vehicle 10 via the communication interface 21, boarding information indicating a user who is on board the vehicle 10 and positional information for the vehicle 10, and determine, using association information associating users who can board the vehicle 10 with allowable ranges of travel, whether the vehicle 10 is located within an allowable range of travel associated with the user who is on board the vehicle 10. The aforementioned configuration enables the server 20 to determine whether the vehicle 10 is located within an allowable range associated with the user who is on board the vehicle 10. This enables the information processing system 1 to improve the utility of technology for limiting a range where the vehicle 10 can be used.

In the server 20 according to the present embodiment, when it is determined that the vehicle 10 is not located within the allowable range of travel, the controller 23 can transmit information indicating the determination result. With this configuration, the server 20 can notify an owner or the like of the vehicle 10 that the vehicle 10 is not located within the allowable range of travel.

In the server 20 according to the present embodiment, the allowable ranges of travel may be defined according to the degrees of reliability of the users. This configuration eliminates the need for an owner of the vehicle 10 or others to define the allowable range of travel for the user, in using the information processing system 1. This enables an owner of the vehicle 10 to save time and labor, and thus the utility of technology for limiting a range where the vehicle 10 can be used is further improved.

In the server 20 according to the present embodiment, the degrees of reliability of the users may be defined based on activities of the users in a social networking service. This enables an owner of the vehicle 10 to define the allowable range of travel for a user based on the activities of the user in a social networking service, even in a case in which the owner of the vehicle 10 does not have sufficient information on the user.

In the server 20 according to the present embodiment, users may be classified into a plurality of categories according to the degrees of reliability of the users, and the allowable ranges of travel may each be defined per category. This enables to save the processing capacity of the server 20, such as the processing speed and the amount of data, which is otherwise required for managing the association information, as compared with the case in which the allowable ranges of travel are individually defined for each user.

In the server 20 according to the present embodiment, in a case in which it is determined that a plurality of users is on board the vehicle 10, the controller 23 can determine whether the vehicle 10 is located within an allowable range of travel associated with at least one user in the plurality of users. This configuration enables the server 20 to determine, even when a plurality of users is on board the vehicle 10, whether the vehicle 10 is located within an allowable range associated with a user who is on board the vehicle 10. Thus, the utility of technology for limiting a range where the vehicle 10 can be used is further improved.

In the server 20 according to the present embodiment, users are associated with degrees of priority, and the controller 23 can determine, in a case in which it is determined that a plurality of users is on board the vehicle 10, whether the vehicle 10 is located within an allowable range of travel associated with a user whose degree of priority is highest among the plurality of users. This configuration enables the server 20 to determine whether the vehicle 10 is located within an allowable range associated with a user who is on board the vehicle 10, based on the degree of priority of the user. This enables an owner of the vehicle 10 to more freely design the determination to be made by the server 20.

In the server 20 according to the present embodiment, the allowable ranges of travel may be defined according to time of day when the users board the vehicle 10. This enables an owner of the vehicle 10 to more freely design the determination to be made by the server 20.

In the server 20 according to the present embodiment, the controller 23 can determine, using the association information, a user who can drive the vehicle 10, based on information on the destination of the vehicle 10. This configuration enables the server 20 to recommend a user of the vehicle 10 to an owner of the vehicle 10, according to the use application of the vehicle 10. This enables the server 20 to reduce the probability that the vehicle 10 will be out of an allowable range associated with a user who is on board the vehicle 10.

The communication apparatus 16 according to the present embodiment is a communication apparatus 16 included in a vehicle 10, the communication apparatus 16 including a communication interface 13, and a controller 15 configured to transmit, to a server 20 via a communication interface 13, information indicating a user who is on board the vehicle and positional information for the vehicle 10, and cause the server 20 to determine, using association information associating users who can board the vehicle 10 with allowable ranges of travel, whether the vehicle 10 is located within an allowable range of travel associated with the user who is on board the vehicle 10. This configuration enables the communication apparatus 16 included in the vehicle 10 to cause the server 20 to determine whether the vehicle 10 is located within an allowable range associated with a user who is on board the vehicle 10. This enables the information processing system 1 to improve the utility of technology for limiting a range where the vehicle 10 can be used.

In the communication apparatus 16 according to the present embodiment, the information indicating the user who is on board the vehicle 10 may be an image of the user who is on board. This configuration enables the communication apparatus 16 to cause the server 20 to determine whether the vehicle 10 is located within an allowable range associated with a user who is on board the vehicle 10, without requiring the user of the vehicle 10 to carry any special device or to perform any special operation.

While the present disclosure has been described with reference to the drawings and examples, it should be noted that various modifications and revisions can be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

For example, in the aforementioned embodiment, all or some of the functions or processes described as the functions or processes of the server 20 may be realized as the functions or processes of the communication apparatus 16 of the vehicle 10. Specifically, a program in which processes for realizing functions of the server 20 according to the embodiment are written may be stored in a memory of the communication apparatus 16 or the like, and the program can be read and executed by a processor of the communication apparatus 16 or the like. For example, in the aforementioned embodiment, the process of identifying a user, based on an image obtained by photographing a user on board, is illustrated as the process to be executed by the server 20; however, the process may be executed by the communication apparatus 16. This enables to reduce the amount of processing to be executed by the server 20 or the amount of data communication between the server 20 and the terminal apparatus 30.

Further, for example, a general purpose computer such as a smartphone may be configured to function as the communication apparatus 16 or the server 20 of the aforementioned embodiment. Specifically, a program in which processes for realizing the functions of the communication apparatus 16 or the server 20 according to the embodiment are written is stored in a memory of a computer, and the program is read and executed by a processor of the computer. For example, in a case in which a general purpose computer is configured to function as the communication apparatus 16 of the vehicle 10, such a configuration may be realized by installing a computer having the configuration and function of the communication apparatus 16 of the vehicle 10 described above on the vehicle 10.

Further, for example, in the aforementioned embodiment, the server 20 is explained as having stored in advance association information associating users who can board the vehicle 10 with allowable ranges of travel, in the memory 22. However, at least part of the association information may be stored in another server or an electronic device such as a portable recording medium. In such a case, the server 20 may acquire as appropriate the association information from the electronic device when necessary.

1. A server comprising:
a communication interface; and
a controller configured to:
receive, from a vehicle via the communication interface, boarding information indicating a user who is on board the vehicle and positional information for the vehicle; and
determine, using association information associating users who can board the vehicle with allowable ranges of travel, whether the vehicle is located within an allowable range of travel associated with the user who is on board the vehicle.

2. The server according to claim 1, wherein the controller is configured to transmit, in a case in which it is determined that the vehicle is not located within the allowable range of travel, information indicating a determination result.

3. The server according to claim 1, wherein the allowable ranges of travel are defined according to degrees of reliability of the users.

4. The server according to claim 3, wherein the degrees of reliability of the users are defined based on activities of the users in a social networking service.

5. The server according to claim 3, wherein the users are classified into a plurality of categories according to the degrees of reliability of the users, and the allowable ranges of travel are each defined per category.

6. The server according to claim 1, wherein the controller is configured to determine, in a case in which it is determined that a plurality of users is on board the vehicle, whether the vehicle is located within an allowable range of travel associated with at least one user in the plurality of users.

7. The server according to claim 6, wherein
the users are associated with degrees of priority, and
the controller is configured to determine, in a case in which it is determined that a plurality of users is on board the vehicle, whether the vehicle is located within an allowable range of travel associated with a user whose degree of priority is highest among the plurality of users.

8. The server according to claim 1, wherein the allowable ranges of travel are defined according to time of day when the users board the vehicle.

9. The server according to claim 1, wherein the controller is configured to determine, using the association information, a user who can drive the vehicle, based on information on a destination of the vehicle.

10. A non-transitory computer readable medium storing a program configured to cause a computer to execute operations, the operations comprising:
receiving, from a vehicle via a communication interface, boarding information indicating a user who is on board the vehicle and positional information for the vehicle; and
determining, using association information associating users who can board the vehicle with allowable ranges of travel, whether the vehicle is located within an allowable range of travel associated with the user who is on board the vehicle.

11. The non-transitory computer readable medium according to claim 10, wherein the operations further comprise transmitting, in a case in which it is determined that the vehicle is not located within the allowable range of travel, information indicating a determination result.

12. The non-transitory computer readable medium according to claim 10, wherein the allowable ranges of travel are defined according to degrees of reliability of the users.

13. The non-transitory computer readable medium according to claim 12, wherein the degrees of reliability of the users are defined based on activities of the users in a social networking service.

14. The non-transitory computer readable medium according to claim 12, wherein the users are classified into a plurality of categories according to the degrees of reliability of the users, and the allowable ranges of travel are each defined per category.

15. The non-transitory computer readable medium according to claim 10, wherein the determining of whether the vehicle is located within an allowable range of travel includes determining, in a case in which it is determined that a plurality of users is on board the vehicle, whether the vehicle is located within an allowable range of travel associated with at least one user in the plurality of users.

16. The non-transitory computer readable medium according to claim 15, wherein
the users are associated with degrees of priority, and
the determining of whether the vehicle is located within an allowable range of travel includes determining, in a case in which it is determined that a plurality of users is on board the vehicle, whether the vehicle is located within an allowable range of travel associated with a user whose degree of priority is highest among the plurality of users.

17. The non-transitory computer readable medium according to claim 10, wherein the allowable ranges of travel are defined according to time of day when the users board the vehicle.

18. The non-transitory computer readable medium according to claim 10, wherein the operations further comprise determining, using the association information, a user who can drive the vehicle, based on information on a destination of the vehicle.

19. A communication apparatus included in a vehicle, the communication apparatus comprising:
a communication interface; and
a controller configured to transmit, to a server via the communication interface, information indicating a user who is on board the vehicle and positional information for the vehicle, and cause the server to determine, using association information associating users who can board the vehicle with allowable ranges of travel, whether the vehicle is located within an allowable range of travel associated with the user who is on board the vehicle.

20. The communication apparatus according to claim 19, wherein the information indicating the user who is on board the vehicle includes an image of the user who is on board.
